(19) United States
(12) Patent Application Publication
(10) Pub. No.: US 2026/0250487 A1
(43) Pub. Date: Aug. 27, 2026

(54) Filler, Resin Composition, And Method For Producing Filler

(71) Applicant: SEIKO EPSON CORPORATION, Tokyo (JP)

(72) Inventors: Yoshiki NAKASHIMA, Suwa (JP); Hideki TANAKA, Chino (JP); Yoko SEKI, Chino (JP); Daisuke IKEDA, Suwa (JP); Sayaka YAMASAKI, Chino (JP)

(21) Appl. No.: 19/549,263

(22) Filed: Feb. 25, 2026

(30) Foreign Application Priority Data
Feb. 26, 2025 (JP) 2025-028730

(51) Int. Cl. C08K 9/04

(52) U.S. Cl. CPC C08K 9/04; C08K 2201/002

(57) ABSTRACT

Provided is a filler to be compounded with a resin. The filler contains particles containing cellulose as a main component. The cellulose positioned on the surface of the particles is derivatized. The apparent density of the particles is 1.0 g/cm³ or less.

The present application is based on, and claims priority from JP Application Serial Number 2025-028730, filed Feb. 26, 2025, the disclosure of which is hereby incorporated by reference herein in its entirety.

### BACKGROUND

### 1. Technical Field

The present disclosure relates to a filler, a resin composition, and a method for producing a filler.

### 2. Related Art

In an attempt to replace petroleum-derived materials with natural materials for plastics, addition of wood-derived cellulose as a filler to plastics has been developed.

For example, JP-A-2019-006997 discloses a fiber-reinforced resin composition having a specific chemical structure in which chemically modified microfibrillated cellulose-based fibers obtained by wet defibration of pulp followed by esterification, an inorganic filler, and a thermoplastic resin are compounded, attempting to obtain a fiber-reinforced resin composition and a molded article thereof that are lightweight and have excellent strength properties.

However, the plastic composite with cellulose added as a filler has low compatibility at the interface between the plastic and the cellulose, and thus there has been a problem in that the interface is easily broken and the strength is insufficient. In addition, when the resin and the cellulose are compounded, the density tends to increase, and there has been a demand for weight reduction of the composite.

### SUMMARY

An aspect of a filler according to the present disclosure is a filler to be compounded with a resin, the filler containing particles containing cellulose as a main component, wherein the cellulose positioned on a surface of the particles is derivatized, and an apparent density of the particles is 1.0 g/cm3 or less.

An aspect of a resin composition according to the present disclosure contains the filler and the resin.

An aspect of a method for producing a filler according to the present disclosure includes a pulverizing step of pulverizing cellulose to obtain cellulose particles having pores, and a derivatizing step of derivatizing the particles in a liquid to derivatize the cellulose positioned on a surface and in an outer edge portion of the particles.

### BRIEF DESCRIPTION OF THE DRAWINGS

FIG. 1 is Table 1 showing the results of experimental examples.

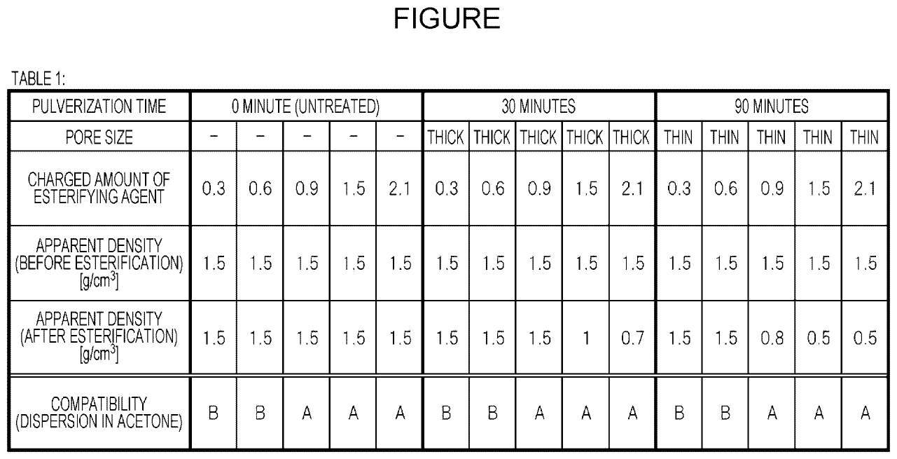

### DESCRIPTION OF EMBODIMENTS

Hereinafter, embodiments of the present disclosure will be described. The embodiments described below describe examples of the present disclosure. The present disclosure is not limited to the following embodiments, and includes various modifications implemented within a range not changing a gist of the present disclosure. It should be noted that not all of the configurations described below are essential configurations of the present disclosure.

In the present specification, a numerical range indicated by using “to” means a range including numerical values described before and after “to” as a lower limit value and an upper limit value.

### 1. Filler

The filler according to the present embodiment is a filler to be compounded with a resin, and contains particles containing cellulose as a main component, wherein the cellulose positioned on a surface of the particles is derivatized, and an apparent density of the particles is 1.0 g/cm³ or less.

### 1.1. Particles

The filler according to the present embodiment contains particles containing cellulose as a main component. The filler can be handled as a powder containing a large number of particles. The filler may have a particle size distribution when viewed as a powder of particles. The average particle size of the filler powder is, for example, 3 μm or more and 400 μm or less, preferably 5 μm or more and 150 μm or less, and more preferably 10 μm or more and 80 μm or less. The particle size distribution of the filler powder can be measured, for example, using a particle size distribution analyzer (for example, “Microtrac UPA” manufactured by Nikkiso Co., Ltd.) using a dynamic light scattering method as a measurement principle.

The amount of cellulose in the case of the content of cellulose in the particles refers to the total amount of unmodified cellulose and derivatized cellulose described below. The content of cellulose in the particles may be 55% by mass or more in terms of the main component, and is preferably 80% by mass or more, more preferably 90% by mass or more, and even more preferably 95% by mass or more.

### 1.1.1. Cellulose

The raw material of the cellulose forming the particles is not particularly limited so long as it contains cellulose. Examples of the cellulose raw material include pulp (sheets and bales of broad-leaved trees, coniferous trees, kenaf, bagasse, kapok, and the like), kraft pulp, dissolving pulp, sulfite pulp, paper (copy paper, printing paper, cardboard, and the like), waste paper, tissue paper, kitchen paper, cleaners, filters, liquid absorbing materials, sound absorbers, cushioning materials, mats, and corrugated cardboard. As the cellulose raw material, a plurality of kinds of those exemplified may be used. The cellulose raw material subjected to a treatment such as bleaching may be used. Among these, dissolving pulp is more preferably used as the raw material of the filler of the present embodiment because the purity of a derivative is increased due to its high cellulose purity.

The particles containing cellulose as a main component can be obtained by pulverizing the cellulose raw material. The pulverization of the cellulose raw material will be described below. In a state where the cellulose raw material is pulverized, that is, in a state before derivatization described below, the pulverized particles have pores (open pores) and internal voids (closed pores) throughout the particles. In the present specification, “particles containing cellulose as a main component” may be simply referred to as “cellulose particles.”

Cellulose is an abundant natural material derived from plants, and can more suitably cope with environmental problems, saving of buried resources, and the like. It is preferable also from the viewpoint of supply of composites produced using cellulose, cost reduction, and the like. In addition, cellulose has a particularly high theoretical strength among various materials, and is advantageous also from the viewpoint of further improving the strength of composites or molded articles. Furthermore, cellulose has good biodegradability.

### 1.1.2. Derivatization

The cellulose positioned on the surface of the above-described particles containing cellulose as a main component is derivatized. Cellulose can be derivatized by esterification, etherification, or the like. In the particles containing cellulose as a main component constituting the filler of the present embodiment, at least the cellulose positioned on the surface thereof is derivatized.

Formula (1) below is an example of a reaction formula showing esterification as an example of the derivatization of cellulose.

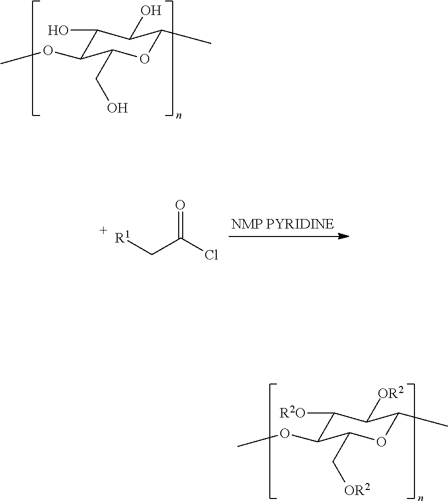

In Formula (1) above, R¹ represents a saturated or unsaturated alkyl group having 2 to 20 carbon atoms, at least one of the three R² represents a saturated or unsaturated alkylcarbonyl group having 2 to 20 carbon atoms, and the remaining R² represent a hydrogen atom.

In Formula (1) above, R¹—CH₂—(C═O)—Cl is used as an esterifying agent, but a plurality of kinds of R¹—CH₂—(C═O)—Cl in which R¹ are different from each other may be used. When two or more R² as the saturated or unsaturated alkylcarbonyl group having 2 to 20 carbon atoms are formed, they may be the same or different.

As shown in Formula (1) above, cellulose is reacted with an acid chloride in a solvent (in the example of Formula (1), N-methylpyrrolidone (NMP) and pyridine), whereby some or all of the hydroxy groups are esterified. In this case, the acid chloride serves as an esterifying agent.

When derivatization is performed by etherification, examples of an etherifying agent include alkyl halides, and etherification of cellulose can be performed in an appropriate solvent.

The cellulose particles are derivatized in the solvent, whereby at least the cellulose present on the surface thereof is derivatized. In addition, the pulverized cellulose particles have pores and internal voids, and the cellulose present inside the surface can also be derivatized by a derivatizing agent that has entered the pores.

Cellulose expands in volume due to derivatization. As a result, the pores of the cellulose particles are narrowed or blocked. As a result, the derivatizing agent is less likely to enter the inside of the cellulose particles, and pores and internal voids remain near the center of the cellulose particles. In other words, the outer edge portion of the cellulose particles is derivatized, whereas the inside thereof is less likely to be derivatized.

Here, the outer edge portion refers to a shell-like portion in a distance range of 50%, preferably in a range of 30%, and more preferably in a range of 10% from the surface of the cellulose particle toward the center when the cellulose particle is assumed to be a sphere. When the cellulose particle has an irregular shape, the center of gravity may be considered as the center, and the outer edge portion similarly refers to a shell-like portion in a distance range of 50%, preferably in a range of 30%, and more preferably in a range of 10% from the surface of the cellulose particle toward the center of gravity.

The cellulose positioned on the surface of the cellulose particles tends to have a higher degree of substitution by derivatization than the cellulose positioned in the outer edge portion of the cellulose particles. As a result, pores and internal voids are likely to remain near the center of the cellulose particles. As a result, the compatibility with the resin can be further improved, internal voids are easily formed, and a composite having more excellent strength and a lighter weight is easily formed.

### 1.1.3. Structure of Particles

The cellulose particles derivatized as described above have pores and internal voids inside. As a result, even when compounded with the resin, the resin does not enter the internal voids, and the internal voids are easily maintained as they are. This can easily keep the apparent density of the particles low.

In addition, the cellulose particles have a higher apparent density in the outer edge portion than in the central portion. This easily keeps the apparent density of the particles low, and easily forms a lightweight composite.

### 1.1.4. Apparent Density of Particles

The apparent density of the cellulose particles constituting the filler of the present embodiment is 1.0 g/cm³ or less. The apparent density of the cellulose particles is preferably 0.9 g/cm³ or less, and more preferably 0.8 g/cm³ or less.

Here, “apparent density” refers to a density obtained by using a volume occupied by an object itself and a volume of internal voids as a volume for density calculation. That is, the apparent density is a density when the internal voids of the object are included in the volume of the object and the pores are not included in the volume. The apparent density can be measured by the Le Chatelier pycnometer method, an immersion method, or the like.

On the other hand, “true density” is a density obtained by using only the volume occupied by a substance itself as the volume for density calculation. That is, the true density refers to a density when neither pores nor internal voids are included in the volume. The true density can be determined by a pycnometer method or the like. The true density of cellulose is about 1.5 g/cm³.

### 1.2. Resin

The filler of the present embodiment is compounded with a resin. Such a resin is not particularly limited, and examples thereof include one kind or a mixture of two or more kinds selected from polyvinyl chloride, polyvinylidene chloride, polyvinyl alcohol, polyvinyl acetate, polystyrene, polyisoprene, polymethacrylic acid, polycarbonate, cellulose acetate, an acrylonitrile-butadiene-styrene copolymer, polyethylene, polypropylene, polyacetal, polyamide, a fluororesin, chlorinated polyether, and polyester.

The resin with which the filler of the present embodiment is compounded is preferably one kind or a mixture of two or more kinds selected from polyvinyl chloride, polyvinylidene chloride, polyvinyl alcohol, polyvinyl acetate, polystyrene, polyisoprene, polymethacrylic acid, polycarbonate, cellulose acetate, an acrylonitrile-butadiene-styrene copolymer, polyethylene, polypropylene, and polyacetal.

When the filler of the present embodiment is compounded with these resins, the compatibility with the resin is more easily obtained, and a composite having more excellent strength and a lighter weight is easily formed.

1.2.1 Compounding with Resin

The filler of the present embodiment can be compounded with the above-described resin to form a composite (resin composition). As the method for compounding, for example, known methods such as melt kneading and solution mixing can be used. In addition, in compounding, additives such as a coloring material, an antioxidant, and an ultraviolet absorber may be blended.

In the filler of the present embodiment, since the vicinity of the surface of the cellulose particles is derivatized, the compatibility with the resin is high, and the flexibility near the surface is also improved. Therefore, the composite can be easily formed by a method such as melt kneading.

### 1.3. Effects and Mechanisms

The filler of the present embodiment can produce a composite that is easily compounded with the resin and more lightweight. That is, in this filler, at least the cellulose on the surface of the particles is hydrophobized by derivatization, and therefore, the compatibility with the resin is improved, and even when compounded with the resin, interfacial peeling is less likely to occur, and a composite having good strength can be obtained. In addition, since the apparent density of the particles is 1.0 g/cm³ or less, it is smaller than the true density of cellulose and the cellulose derivative that is 1.5 g/cm³. This can form a lightweight composite.

The apparent density of the cellulose particles of the filler of the present embodiment is relatively low on the inside and high on the outside (the outer edge portion). Therefore, when mixed with the resin, the outer shell having a higher density inhibits the entry of the resin, and thus the internal voids are less likely to be filled with the resin, thus achieving a weight reduction in the composite when compounded.

### 2. Resin Composition

The resin composition according to the present embodiment contains the above-described filler and the above-described resin. The resin composition of the present embodiment can produce a molded article having excellent strength as a result of good dispersion of the cellulose particles of the above-described filler and having a light weight due to the structure and the apparent density of the above-described cellulose particles.

### 3. Method for Producing Filler

The method for producing a filler according to the present embodiment is a method for producing the above-described filler to be compounded with the resin, and includes a pulverizing step of pulverizing cellulose to obtain cellulose particles having pores, and a derivatizing step of derivatizing the particles in a liquid to derivatize the cellulose positioned on a surface and in an outer edge portion of the particles.

### 3.1. Pulverizing Step

The method for pulverizing cellulose is not particularly limited, and a known method can be used. The pulverization can be performed using a bead mill, a ball mill, an FM mixer, a Henschel mixer, a super mixer, a turbo mill, a roller mill, a jet mill, a hammer mill, a pin mill, or the like. The pulverization treatment may be performed while cooling.

The pulverization of cellulose is more preferably performed with a bead mill or a ball mill. When the bead mill is used, it is easy to more uniformly distribute pores in the pulverized cellulose particles. Examples of the bead mill apparatus include a dry bead mill Drystar (registered trademark) SDA1 (manufactured by Ashizawa Finetech Ltd.), and beads of a material such as zirconia or SUS can be used, for example.

### 3.2. Derivatizing Step

The derivatization of the cellulose particles can be performed, for example, by reacting the cellulose particles with an acid chloride in NMP. This causes a reaction in which cellulose molecules on the surface of the cellulose particles are substituted (esterified) to be made into a derivative. Since molecules that have had a high degree of substitution are eluted into NMP, the surface of the cellulose particles is always maintained in a state of being coated with cellulose having a low degree of substitution. On the other hand, the cellulose molecules that have had a high degree of substitution expand in volume, thus narrowing or blocking the pores of the cellulose particles. Therefore, the outer edge portion of the cellulose particles is derivatized, and unreacted cellulose, pores, and internal voids remain on the inside thereof.

In order to stop this derivatization reaction in the middle, the charged amount of the esterifying agent may be adjusted. The substituted functional group has high compatibility with the above-described resin, and a composite having a strong interface between the resin and the cellulose particles can be obtained by mixing (compounding) the powder of the cellulose particles subjected to this treatment (the above-described filler) with the resin.

### 3.3. Other Steps

The method for producing a filler of the present embodiment may include, for example, steps such as a washing step, a filtering step, a drying step, and a classifying step apart from the pulverizing step and the derivatizing step.

The method for producing a filler of the present embodiment can derivatize cellulose from the surface of the cellulose particles toward the inside thereof. As a result, swelling occurs in the range from the surface to the outer edge portion of the cellulose particles, and pores near the surface are blocked, thus making it easy to cause pores and internal voids to remain near the center of the cellulose particles. This can easily make the apparent density of the cellulose particles 1.0 g/cm³ or less.

### 4. Experimental Examples

Hereinafter, the present disclosure will be specifically described with reference to experimental examples, but the present disclosure should not be limited to these experimental examples. Hereinafter, “part” and “%” are based on mass unless otherwise specified. Unless otherwise specified, the evaluation is carried out in an environment of a temperature of 25° C. and a relative humidity of 40.0%.

### 4.1. Preparation of Filler

### 4.1.1. Pulverization

Dissolving pulp was used as a raw material. The dissolving pulp was pulverized with a bead mill (Drystar (registered trademark) SDA1 (manufactured by Ashizawa Finetech Ltd.)). Zirconia beads (diameter: 3 mm) were used as the beads. The filling rate of the beads was set to 70% (volume-based), the stirring condition was set to a peripheral speed of 2 to 7 m/s, and the cellulose charging rate was set to 0.2 to 1 kg/h. The humidity inside the apparatus was set to 808. It is noted that the reason why the humidity was set to 80% is that the contact among the particles is enhanced and pores are more easily formed.

Samples of the filler powder with pulverization times of 30 minutes and 60 minutes were obtained. The pore size of the obtained filler was measured with a transmission electron microscope, and the filler having a pore size of 100 nm or less was described as “thin,” whereas the filler having a pore size exceeding 100 nm was described as “thick” in Table 1. It is noted that the untreated dissolving pulp was considered to have no pores, and the pore size was not measured.

### 4.1.2. Derivatization

The filler powder obtained above was esterified (derivatized) as follows. After performing the pulverization treatment on the cellulose, esterification was performed in a solid-liquid heterogeneous system. Specifically, 6.0 g of the cellulose powder (in terms of dry weight, 37 mmol/glucose unit) was charged into a reaction vessel, dispersed in 240 ml of pyridine in a nitrogen atmosphere, and stirred at room temperature overnight to be activated. The dispersion liquid was then cooled to about 10° C., and 3.18 g (10.8 mmol) of stearoyl chloride and 6.22 g (67.0 mmol) of propionyl chloride were premixed and charged into the reaction vessel. After stirring the mixture while heating at 90° C. for 4 hours, 23 g of a 13% aqueous sodium hydroxide solution was slowly added dropwise, and the mixture was stirred for 1 hour while cooling to 40° C. Water in an amount of 260 ml was further added to precipitate a product, which was collected by suction filtration. The obtained solid was washed with 200 ml of water twice, and then washed with 200 ml of methanol (3 to 4 times) until the color of the filtrate disappeared. The washed solid was vacuum-dried at 105° C. for 5 hours to obtain 10.0 g (yield: 98%) of a powdery cellulose filler (cellulose propionate stearate).

In the derivatization treatment, the charged amount of the esterifying agent is (10.8+67.0)/37=2.1. The charged amount of the esterifying agent was changed as described in Table 1 to prepare fillers of the respective experimental examples.

### 4.2. Evaluation of Filler

As described above, the experiment was performed by changing the pulverized state and the charged amount of the esterifying agent, and the apparent density was measured by the JIS Z 8807:2012 Le Chatelier pycnometer method. The measured values of the apparent density are described in Table 1.

The dispersibility in acetone was evaluated.

Acetone and each filler (0.1% by mass) were sealed in a sample cell of a dispersion stability analyzer LUMiSizer (manufactured by LUM), dispersed by performing an ultrasonic treatment of 50 W for 60 seconds using an ultrasonic homogenizer UX-050 manufactured by Mitsui Electric Co., Ltd., and left to stand for 10 seconds.

Thereafter, the apparatus was operated, and the cell transmissivity (absorbance) of laser light after 5 minutes at a centrifugal acceleration of 10G was measured. The measurement positions were a ¼ position and a ¾ position of the entire length of the cell from the end of the cell.

Since the ratio of absorbance is the ratio of concentration, A_{1/4}/A_{3/4}=C_{1/4}/C_{3/4}. Where A_{1/4} is the absorbance at the ¼ position of the entire length of the cell from the end of the cell, A_{3/4} is the absorbance at the ¾ position of the entire length of the cell from the end of the cell, C_{1/4} is the concentration at the ¼ position of the entire length of the cell from the end of the cell, and C_{3/4} is the concentration at the ¾ position of the entire length of the cell from the end of the cell.

As the evaluation of acetone dispersibility, the value of C_{1/4}/C_{3/4} being in a range of 0.1 or more and 10 or less is evaluated as “A,” the value being less than 0.1 or more than 10 and 0.01 or more or 100 or less is evaluated as “B,” and the value being in other ranges is evaluated as “C.” The results of the respective experimental examples are described in Table 1.

### 4.3. Evaluation Results

The following findings were obtained from the above experimental examples.
Since the raw material before pulverization (untreated) had no pores, the apparent density did not change even when esterification was performed.
The product pulverized with the bead mill is an aggregate of fine particles and has pores. When this is esterified, the apparent density changes and becomes smaller. This is considered to be a result of the fact that being esterified caused volume expansion, and some pores on the particle surface were closed to become internal voids.
The dispersibility in acetone was evaluated as an alternative method for evaluating the compatibility with the resin, and it was found that good dispersibility of the filler in acetone was achieved when the esterifying agent was reacted at a charged amount of 0.9 or more relative to the equivalent.
It is considered that if the dispersibility in acetone is good, the dispersibility in a resin having low acetone resistance, that is, having a good affinity for acetone is good. Examples of the resin having low acetone resistance (high affinity for acetone) include polyvinyl chloride, polyvinylidene chloride, polyvinyl alcohol, polyvinyl acetate, polystyrene, polyisoprene, polymethacrylic acid, polycarbonate, cellulose acetate, an acrylonitrile-butadiene-styrene copolymer, polyethylene, polypropylene, and polyacetal, which are described above.

The present disclosure includes a configuration substantially the same as the configuration described in the embodiment, for example, a configuration having the same function, method, and result, or a configuration having the same object and effect. In addition, the present disclosure also includes a configuration in which a non-essential part of the configuration described in the embodiment is replaced. In addition, the present disclosure includes a configuration that exhibits the same effects as the configuration described in the embodiment or a configuration that can achieve the same object. In addition, the present disclosure includes a configuration in which a known technique is added to the configuration described in the embodiment.

The following contents are derived from the above-described embodiments and modifications.

The filler is a filler to be compounded with a resin, and contains particles containing cellulose as a main component, wherein the cellulose positioned on a surface of the particles is derivatized, and an apparent density of the particles is 1.0 g/cm³ or less.

This filler can produce a composite that is easily compounded with the resin and more lightweight. That is, in this filler, at least the cellulose on the surface of the particles is hydrophobized by derivatization, and therefore, the compatibility with the resin is improved, and even when compounded with the resin, interfacial peeling is less likely to occur, and a composite having good strength can be obtained. In addition, since the apparent density of the particles is 1.0 g/cm³ or less, it is smaller than the true density of cellulose and the cellulose derivative that is 1.5 g/cm³. This can form a lightweight composite.

In the filler, the particles may have internal voids.

Since this filler has internal voids in the particles, even when the filler is compounded with the resin, the resin does not enter the internal voids, and the internal voids are easily maintained as they are. This can easily keep the apparent density of the particles low.

In the filler, the particles may have a higher apparent density in an outer edge portion than in a central portion.

This filler easily keeps the apparent density of the particles low, and easily forms a lightweight composite.

In the filler, the cellulose positioned on the surface of the particles may have a higher degree of substitution by derivatization than the cellulose positioned in the outer edge portion of the particles.

This filler has better compatibility with the resin, and easily forms the internal voids. This easily forms a composite having more excellent strength and a lighter weight.

In the filler, the resin may be one kind or a mixture of two or more kinds selected from polyvinyl chloride, polyvinylidene chloride, polyvinyl alcohol, polyvinyl acetate, polystyrene, polyisoprene, polymethacrylic acid, polycarbonate, cellulose acetate, an acrylonitrile-butadiene-styrene copolymer, polyethylene, polypropylene, and polyacetal.

This filler more easily provides compatibility with the resin, and easily forms a composite having more excellent strength and a lighter weight.

The resin composition contains any of the fillers and the resin.

This resin composition can produce a molded article having excellent strength and a light weight.

The method for producing a filler includes a pulverizing step of pulverizing cellulose to obtain cellulose particles having pores, and a derivatizing step of derivatizing the particles in a liquid to derivatize the cellulose positioned on a surface and in an outer edge portion of the particles.

This method for producing a filler can derivatize cellulose from the surface of the cellulose particles toward the inside thereof. As a result, swelling occurs in the range from the surface to the outer edge portion of the cellulose particles, and pores near the surface are blocked, thus making it easy to cause pores and internal voids to remain near the center of the cellulose particles. This can easily make the apparent density of the cellulose particles 1.0 g/cm³ or less.

What is claimed is:

1. A filler to be compounded with a resin, the filler comprising particles containing cellulose as a main component, wherein
the cellulose positioned on a surface of the particles is derivatized, and
an apparent density of the particles is 1.0 g/cm³ or less.

2. The filler according to claim 1, wherein the particles have internal voids.

3. The filler according to claim 1, wherein the particles have a higher apparent density in an outer edge portion than in a central portion.

4. The filler according to claim 1, wherein the cellulose positioned on the surface of the particles has a higher degree of substitution by derivatization than the cellulose positioned in an outer edge portion of the particles.

5. The filler according to claim 1, wherein the resin is one kind or a mixture of two or more kinds selected from polyvinyl chloride, polyvinylidene chloride, polyvinyl alcohol, polyvinyl acetate, polystyrene, polyisoprene, polymethacrylic acid, polycarbonate, cellulose acetate, an acrylonitrile-butadiene-styrene copolymer, polyethylene, polypropylene, and polyacetal.

6. A resin composition comprising:
the filler according to claim 1; and
the resin.

7. A method for producing a filler to be compounded with a resin, the method comprising:
pulverizing cellulose to obtain cellulose particles having pores; and
derivatizing the particles in a liquid to derivatize the cellulose positioned on a surface and in an outer edge portion of the particles and to make an apparent density of the particles 1.0 g/cm³ or less.
